(19) United States
(12) Patent Application Publication
(10) Pub. No.: US 2003/0086846 A1
(43) Pub. Date: May 8, 2003

(54) Monolith stacking configuration for improved flooding

(76) Inventors: George Y. Adusei, Branchburg, NJ (US); Achim K. Heibel, Nentershausen (DE)

Correspondence Address: CORNING INCORPORATED, SP-TI-3-1, CORNING, NY, 14831

(21) Appl. No.: 10/012,789

(22) Filed: Nov. 5, 2001

(51) Int. Cl. B01J 8/02

(52) U.S. Cl. 422/222; 422/211

(57) ABSTRACT

A device for extending a flooding limit of a packed column includes a stack of monolith segments having a plurality of channels. The monolith segments are stacked in order of increasing channel diameter so as to effectively increase the effective channel hydraulic diameter of the packed column.

### BACKGROUND OF INVENTION

The invention relates to multiphase reactors and to a device and method for enhancing countercurrent flow in multiphase reactors.

Monoliths contain a large number of thin, parallel, straight channels through which fluids, i.e., gas and liquid, can flow. The number of channels in relation to the cross-sectional area of the monolith is referred to as cell density. The cross-section of the channels can be of any arbitrary shape, such as square, rectangular, triangular, hexagonal, circular, etc. Longitudinal fins may also be incorporated in the walls of the channels to increase the surface area of the channels. Monoliths are typically extruded from a ceramic material such as cordierite but may also be manufactured from metal. The walls of the monolith channels may be coated with a porous washcoat containing an active catalyst. Alternatively, an active catalyst may be incorporated into the walls of the monolith channels. In operation, fluids containing reactants flow through the monolith channels. The reactants react in the presence of the active catalyst, and the products of the reaction are transported out of the monolith channels.

Monolith catalysts are well-known for their use as three-way catalytic converters in automobiles. Their low pressure drop for gas-phase reactions allow them to be placed directly into the exhaust pipe of an automobile without affecting the performance of the engine. Monolith catalysts are also widely used for cleaning of industrial flue gas. In recent years, monolith catalysts have been proposed as alternatives to randomly packed pellets in multiphase reactions. One advantage of monolith catalyst beds over randomly packed beds with conventional catalyst pellets is increased contact efficiency between the reactants and the catalytic layer. Also, monolith catalysts can be used in both co-current and countercurrent chemical reactors. In co-current operation, gas and liquid flow in the same direction through the monolith channels. In countercurrent operation, liquid flows down as a wavy falling film on the wall of the monolith channel while gas travels up through the core of the channel.

In counter current flow, the phenomenon of flooding places an upper limit on the gas and liquid flow rates. Flooding in counter current flow is the flow condition in which a normally down-flowing liquid reverses course and begins to flow upwards due to the interactions between the two phases. At the onset of flooding liquid slugs are transported upwardly by the gas moving up the core of the monolith channels. This phenomenon is accompanied by a sharp rise in pressure drop across the monolith catalyst. Flooding has detrimental effects on reactor performance and stability of operation. It places an upper limit on the operating window of counter current reactor operation beyond which the reaction or mass transfer performance of the monolith catalyst deteriorates To prevent flooding and therefore increase the flexibility in the selection of the appropriate channel geometry for an application, various methods have been proposed for enhancing the countercurrent flow characteristics.

One method for enhancing countercurrent flow characteristics involves beveling the liquid outlet end of the monolith channels at an angle, typically of 70° perpendicular to the flow direction. See, Lebens, P. J. M. et al., “Hydrodynamics of gas-liquid countercurrent flow in internally finned monolithic structures,” Chemical Engineering Science, Vol. 52, Nos. 21/22, pp. 3893. Another method for enhancing countercurrent flow characteristics involves aligning a set of parallel plates with the monolith channel walls. The parallel plates have nibs which act as drip points for liquid drainage. See, Lebens, P. J. M. et al., “Hydrodynamics and mass transfer issues in a countercurrent gas-liquid internally finned monolith reactor,” Chemical Engineering Science, Vol. 54, pp. 2383. Typically, the parallel plates with nibs work well when the cell density of the monolith is low, e.g., below 50 cpsi. Guiding of the liquid to the nibs and dripping becomes more difficult when the cell density of the monolith is high, e.g., greater than 50 channels per square inch of cross-sectional area (cpsi).

### SUMMARY OF INVENTION

In one aspect, the invention relates to a device for extending the flooding limit of a packed column which comprises pluralities of flow channels stacked in order of increasing channel diameter. The stacked flow channels successively provide increasing hydraulic area for the flow of the liquid out of the packed column.

In another aspect, the invention relates to a device for extending the flooding limit of a packed column which comprises a stack of monolith segments having a plurality of channels. The monolith segments are stacked in order of increasing channel diameter so as to effectively increase the effective channel hydraulic diameter of the packed column.

In another aspect, the invention relates to a device for extending the flooding limit of a packed column which comprises a monolith segment having a plurality of channels. The monolith segment has a channel diameter and a channel shape which effectively increase the effective channel hydraulic diameter of the packed column.

In another aspect, the invention relates to a chemical reactor having a monolith catalyst bed disposed therein. The chemical reactor comprises a stack of monolith segments mounted at an outlet end of the monolith catalyst bed. The monolith segments have a plurality of channels and are stacked in order of increasing channel diameter so as to effectively increase the effective channel hydraulic diameter of the monolith catalyst bed.

In another aspect, the invention relates to a device for extending a flooding limit of a packed column which comprises a plurality of flow channels stacked in order of increasing diameter so as to effectively increase the effective channel hydraulic diameter of the packed column.

In another aspect, the invention relates to a method for draining fluid out of a packed column so as to extend the flooding limit of the packed column. The method comprises passing fluid from an outlet end of the packed column through a flow column having a plurality of channels stacked in order of increasing effective channel hydraulic diameter.

Other features and advantages of the invention will be apparent from the following description and the appended claims.

### BRIEF DESCRIPTION OF DRAWINGS

FIG. 1 shows one embodiment of an outlet device mounted at an outlet end of a monolith bed in a chemical reactor.

FIGS. 2A and 2B show enlarged views of the outlet device.

FIGS. 2C and 2D show the bottom monolith segment of FIGS. 2A and 2B with a beveled outlet end.

FIG. 3 shows flooding limits as a function of superficial gas and liquid velocities for different stack arrangements and a baseline case without a stacked outlet configuration, where the gas phase is air, the liquid phase is water, and the monolith bed has a cell density of 50 cpsi.

FIG. 4 shows flooding limits as a function of superficial gas and liquid velocities for a stack arrangement and a baseline case without a stacked outlet configuration, where the gas phase is air, the liquid phase is decane, and the monolith bed has a cell density of 100 cpsi.

FIG. 5 shows flooding limits as a function of superficial gas and liquid velocities for a stack arrangement and a baseline case without a stacked outlet configuration, where the gas phase is air, the liquid phase is decane, and the monolith bed has rounded channel shape and a cell density of 25 cpsi.

FIG. 6 shows the effect of misaligning a set of parallel plates (used as drainage enhancer) with the channel walls of a monolith segment, where the gas phase is air, the liquid phase is water, and the monolith bed has square channel shape and a cell density of 25 cpsi.

### DETAILED DESCRIPTION

A device consistent with the principles of the invention enhances countercurrent flow characteristics by effectively draining liquid out of a monolith bed, or packed column in general. Specific embodiments of the invention are described below with reference to the accompanying drawings. In the following description, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

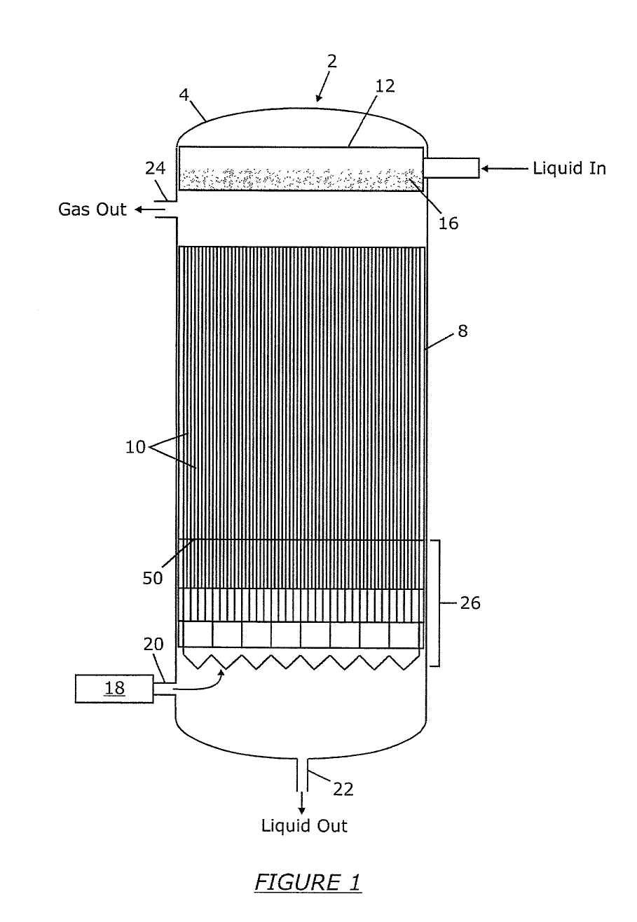

FIG. 1 shows a reactor 2 incorporating an embodiment of the invention. The reactor 2 includes a reactor housing 4 inside which is disposed a monolith bed 8. The monolith bed 8 has a plurality of channels 10 through which fluids can flow. The walls of the channels 10 may be coated with a porous oxide (washcoat) containing catalytic species, or catalytic species may be incorporated directly into the walls of the channels 10. Longitudinal fins (not shown) may also be incorporated in the walls of the channels 10 to increase the surface area of the channels 10.

In countercurrent operation, a liquid distributor 12 mounted above the monolith bed 8 distributes a liquid 16 into the channels 10 in the monolith bed 8. Examples of liquid distributors include, but are not limited to, sparger pipe, sieve tray, trough, picket-fence weir, bubble cap, spray nozzle, shower head, and overflow tube type. The liquid reactant 16 flows down the channels 10 as a wavy liquid film. A gaseous reactant 18 is introduced below the monolith bed 8 through one or more ports 20 in the reactor housing 4. The gas phase 18 flows up through the cores of the channels 10. The byproducts of the reaction between the liquid reactant 16 and the gaseous reactant 18 can be discharged from the reactor housing 4 through the ports 22 and 24.

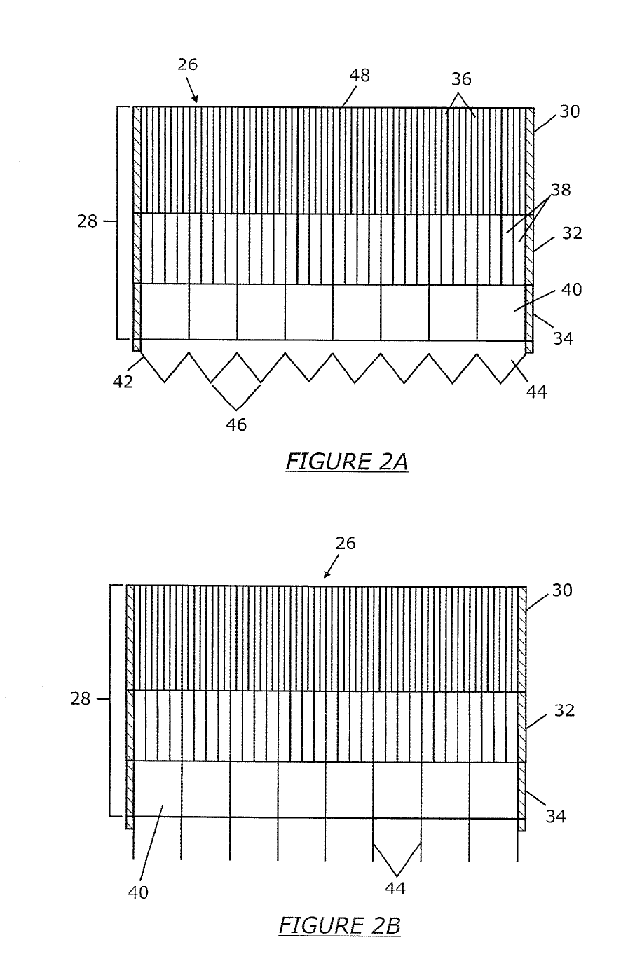

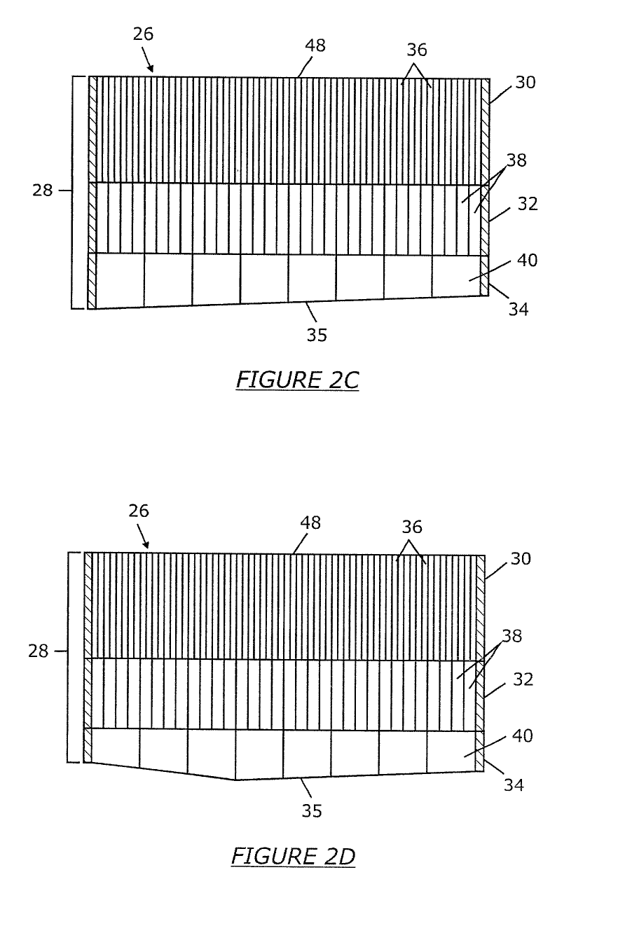

An outlet device 26 is positioned below the monolith bed 8 to assist in draining liquid out of the monolith bed 8. FIG. 2A shows an enlarged view of the outlet device 26. The outlet device 26 includes a monolith stack 28 having monolith segments 30, 32, 34. Typically, the monolith stack 28 includes two or more monolith segments, although a single monolith segment may also be used. The monolith segments 30, 32, 34 have a plurality of channels 36, 38, 40, respectively, through which fluids can flow. The dimensions and shapes of the channels are such that they have limited flow capacity in a non-flooded regime of the monolith bed (8 in FIG. 1). Typically, the monolith segments 30, 32, 34 have different cell densities, where cell density is the number of channels per cross-section area of the monolith segment. The monolith segments 30, 32, 34 are stacked in order of increasing channel (hydraulic) diameter. In other words, the channel diameter of the monolith segment 32 is larger than the channel diameter of the monolith segment 30, and the channel diameter of the monolith segment 34 is larger than the channel diameter of the monolith segment 32. Typically, the channel diameter of the monolith segment 30 at the top of the stack 28 is the same as or larger than the channel diameter of the monolith bed (8 in FIG. 1).

The outlet device 26 may also include a drainage enhancer 42. One example of the drainage enhancer 42 includes a set of parallel plates 44 (see also FIG. 2B) having nibs 46 that act as drip points. Preferably, the parallel plates 44 are aligned with the channel walls of the monolith segment 34 at the bottom of the monolith stack 28 (see also FIG. 2B). Typically, it is easier to align the parallel plates 44 with the monolith segment 34 if the monolith segment 34 has a low cell density and thick channel walls. Other types of devices with reasonable drip points may also be used as a drainage enhancer. Examples of such devices include, but are not limited to, a filtered paper, a perforated plate or disc, or a bundle of tubes. Furthermore, any geometry configuration that enhances flooding behavior may also be used as a drainage enhancer, e.g., single or double beveling of the outlet end 35 of the monolith segment 34 at the bottom of the monolith stack 28 (see FIGS. 2C and 2D).

The outlet device 26 may be integrated into a support grid (not shown) used to fix the monolith bed (8 in FIG. 1) in the reactor housing (4 in FIG. 1). For applications that use a fragile monolith bed or a monolith bed that has to be replaced from time to time, the monolith bed and/or the support grid can be separated from the outlet device 26 and the material of the monolith segments 30, 32, 34 may be selected to fulfill the strength requirements to transfer the weight of the monolith bed and any additional forces to the reactor housing (4 in FIG. 1). Preferably, the upper and lower surfaces of the monolith segments 30, 32, 34 are such that the monolith segments make full contact with each other when stacked together. Typically, this involves flattening the upper and lower surfaces of the monolith segments 30, 32, 34. Flattening the interfaces between the monolith segments 30, 32, 34 enhances the operating window of the reactor. Preferably, the upper surface 48 of the monolith segment 30 is such that it makes full contact with the outlet end (50 in FIG. 1) of the monolith bed (8 in FIG. 1).

The following examples illustrate the effect of monolith stack configuration on flooding limits. It should be noted that the examples presented below are for illustrative purposes only and are not to be construed as limiting the invention unless as otherwise described herein.

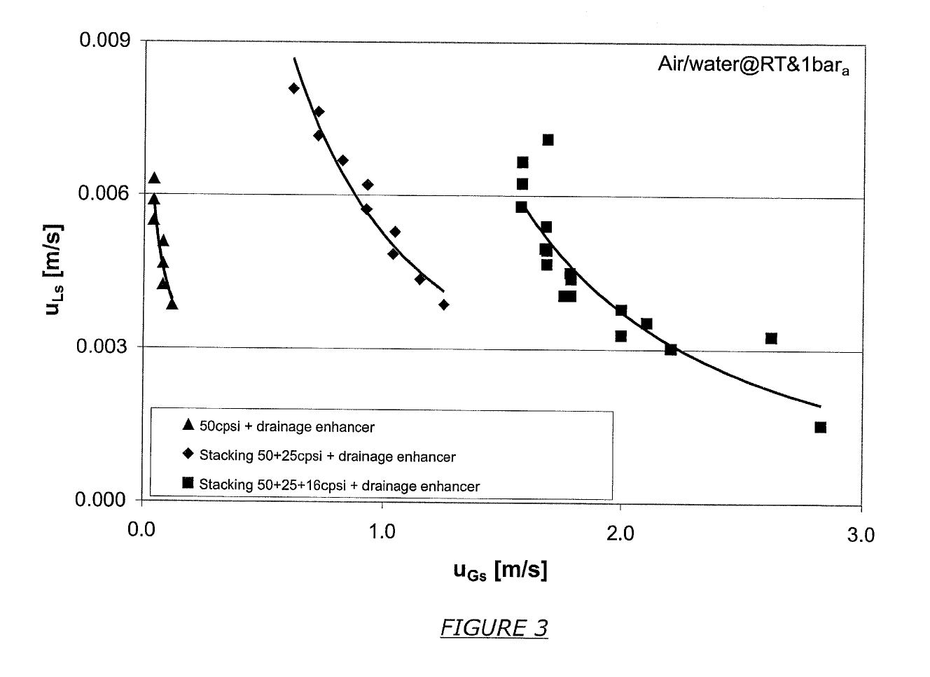

FIG. 3 shows flooding limits as a function of superficial gas and liquid velocities for two monolith stack configurations and a baseline case without a monolith stack. In all cases, the reactor was operated at room temperature and atmospheric pressure. A drainage enhancer, such as item 42 in FIG. 2A, was used at the outlet end of the monolith bed. The monolith bed had a cell density of 50 cpsi, the gas phase was air, and the liquid phase was water. The curve with the triangles represent the baseline case wherein only a drainage enhancer was used with the monolith bed. The curve with the diamonds represent a case where a monolith stack having a monolith segment with a cell density of 25 cpsi was used with the monolith bed. The curve with the squares represent a case where a monolith stack having two monolith segments with cell densities of 25 cpsi and 16 cpsi, respectively, were used with the monolith bed.

For a given liquid velocity, the curves shown in FIG. 3 define the limiting gas velocities for the different stack arrangements. Above these limiting gas velocities, the monolith bed floods. As can be observed, the limiting gas velocity increases with the application of the 25 cpsi monolith segment at the outlet of the monolith bed (see the curve with diamonds). The improvement is even more significant by opening the channel diameter even more with the additional use of a 16 cpsi monolith segment (see the curve with squares). This means that the operating window broadens with the application of a monolith stack at the outlet of the monolith bed. In general, broadening of the operating window allows for more flexibility in selecting the appropriate geometry for the monolith bed, due to the decoupling of the flooding performance from the reactive performance.

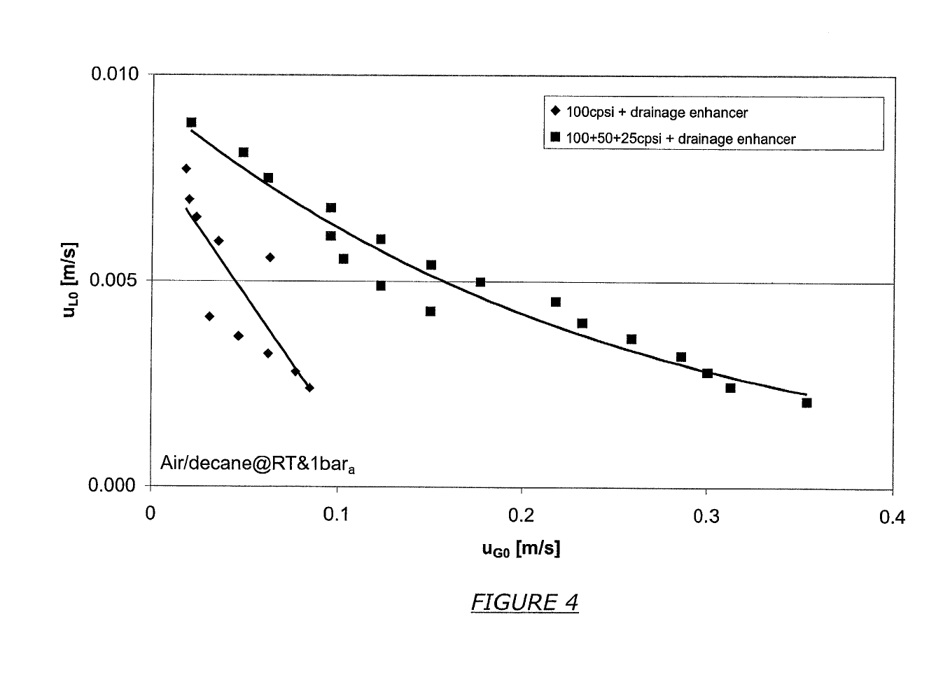

FIG. 4 shows flooding limits as a function of superficial gas and liquid velocities for a monolith stack configuration and a baseline case without a monolith stack. In both cases, the reactor was operated at room temperature and atmospheric pressure. A drainage enhancer, such as item 42 in FIG. 2A, was used at the outlet end of the monolith bed. The monolith bed had a cell density of 100 cpsi, the gas phase was air, and the liquid phase was decane. The curve with the diamonds represent the baseline case wherein only a drainage enhancer was used with the monolith bed. The curve with the squares represent a case where a monolith stack having two monolith segments with cell densities of 50 cpsi and 25 cpsi, respectively, was used with the monolith bed. Again, the case wherein a monolith stack is used with the monolith bed provides a larger operating window than the baseline case that does not involve the use of a monolith stack.

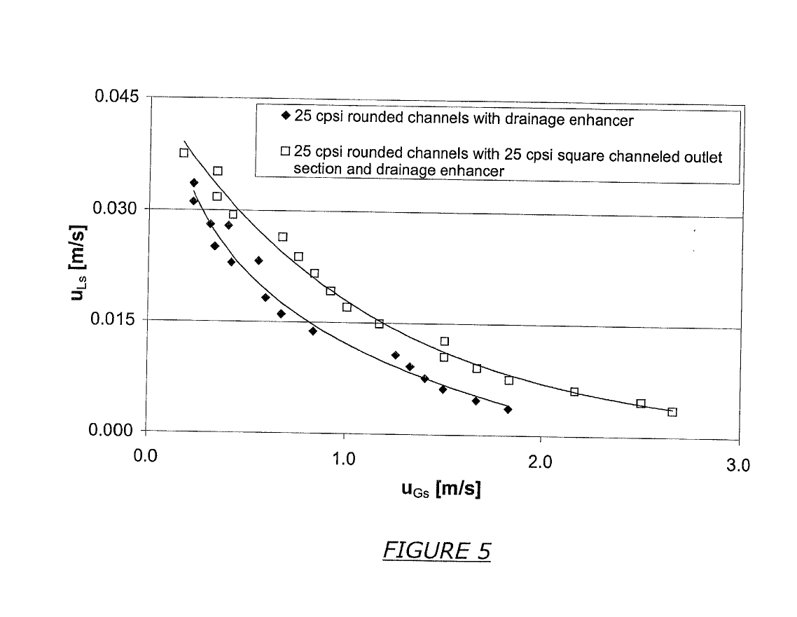

In the examples considered above, the monolith bed and the monolith stack had the same channel shape. FIG. 5 illustrates the effect of different channel shape on flooding limit. For FIG. 5, the monolith bed had a round channel shape, i.e., the cross-section of the channels in the monolith bed is circular, and a cell density of 25 cpsi. In the two examples presented in the figure, a drainage enhancer, such as item 42 in FIG. 2A, was used with the monolith bed. The curve with the diamonds represent the case where only a drainage enhancer was used with the monolith bed. The curve with the squares represent the case where a monolith stack having a monolith segment with a square channel shape and a cell density of 25 cpsi was used with the monolith bed. As shown in the figure, the monolith stack with the square channel shape has a larger operating window than the baseline case that does not include a monolith stack. FIG. 5 shows that channel shape also affects flooding performance.

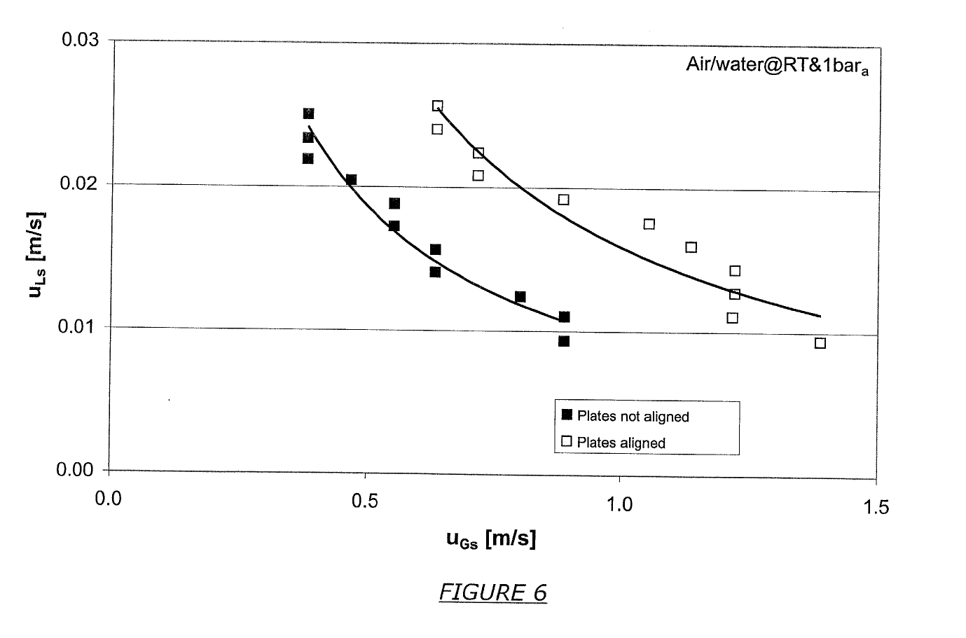

FIG. 6 shows the effects of misaligning a set of parallel plates (used as drainage enhancer) with the channel walls of a monolith segment at the outlet end of a monolith bed, where the gas phase is air, the liquid phase is water, and the monolith bed has square channel shape and a cell density of 25 cpsi. The curve with the unfilled squares represent a case where the parallel plates are aligned with the channel walls of the monolith segment. The curve with the filled squares represent a case where the parallel plates are misaligned with the channel walls of the monolith segment. The results show that aligning the parallel plates with the channel walls is beneficial to flooding performance. However, for a monolith segment having a large diameter and a high cell density, aligning the parallel plates with the channel walls of the monolith segment can be very difficult. Therefore, it is important that the monolith segment at the bottom of the monolith stack has a low cell density and a large channel diameter so that it is easier to align the parallel plates with the channel walls of the monolith segment.

The invention provides one or more advantages. The monolith stack when used at the outlet end of the monolith bed decouples the flooding performance of the monolith bed from the reactive performance of the monolith bed. This allows for more flexibility in selecting the appropriate geometry for the monolith bed which will enhance the reactive performance of the monolith bed. The channel diameter and shape and number of segments in the monolith stack can be selected to achieve a desired flooding performance. A drainage enhancer can be used to further improve the flooding performance of the monolith bed.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A device for extending a flooding limit of a packed column, comprising:
a stack of monolith segments having a plurality of channels, the monolith segments stacked in order of increasing effective channel hydraulic diameter.

2. The device of claim 1, wherein the monolith segments have different cell densities.

3. The device of claim 1, further comprising a drainage device attached to the base of the last monolith segment having the largest channel diameter.

4. The device of claim 3, wherein the drainage device comprises a plurality of drip points for dripping fluid from the monolith segment having the largest channel diameter.

5. The device of claim 3, wherein the drainage device comprises a set of plates having drip points for draining liquid from the flow channels.

6. The device of claim 5, wherein the plates are aligned with the walls of the channels of the monolith segment having the largest channel diameter.

7. The device of claim 3, wherein the drainage device comprises a geometry configuration at an outlet end of the monolith segment having the largest channel diameter.

8. The device of claim 7, wherein the geometry configuration comprises bevels.

9. The device of claim 1, wherein the monolith segment having the smallest channel diameter is adapted to mate with the packed column.

10. The device of claim 9, wherein the channel diameter of the monolith segment adapted to mate with the packed column is the same as the channel diameter of the packed column.

11. The device of claim 9, wherein the channel diameter of the monolith segment adapted to mate with the packed column is larger than the channel diameter of the packed column.

12. The device of claim 1, wherein an interface between adjacent monolith segments is flattened to allow full contact between the monolith segments.

13. The device of claim 1, wherein the packed column is catalyzed.

14. A device for extending a flooding limit of a packed column, comprising:
a monolith segment having a plurality of channels, the monolith segment having a channel diameter and a channel shape which effectively increase the effective channel hydraulic diameter of the packed column.

15. The device of claim 14, wherein the monolith segment has a channel diameter larger than the channel diameter of the packed column.

16. The device of claim 14, wherein the monolith segment has a channel shape different from a channel shape of the packed column.

17. The device of claim 14, further comprising a drainage device mounted adjacent the monolith segment.

18. The device of claim 17, wherein the drainage device comprises a plurality of drip points for dripping fluid from the flow channels.

19. The device of claim 17, wherein the drainage device comprises a set of plates having drip points for dripping fluid from the flow channels.

20. The device of claim 19, wherein the plates are aligned with the walls of the channels of the monolith segment.

21. The device of claim 19, wherein the drainage device comprises a geometry configuration at an outlet end of the monolith segment having the largest channel diameter.

22. The device of claim 21, wherein the geometry configuration comprises bevels.

23. The device of claim 14, wherein the monolith segment is adapted to mate with the packed column.

24. The device of claim 14, wherein the packed column is catalyzed.

25. A chemical reactor having a monolith catalyst bed disposed therein, the reactor comprising:
a stack of monolith segments mounted at an outlet end of the monolith catalyst bed, the monolith segments having a plurality of channels and stacked in order of increasing channel diameter so as to effectively increase a channel diameter of the monolith catalyst bed.

26. The chemical reactor of claim 25, further comprising a drainage device mounted at adjacent the monolith segment having the largest channel diameter.

27. The chemical reactor of claim 26, wherein the drainage device comprises a plurality of drip points for dripping fluid from the flow channels.

28. The chemical reactor of claim 26, wherein the drainage device comprises a set of plates having drip points for dripping fluid from the flow channels.

29. The chemical reactor of claim 28, wherein the plates are aligned with the walls of the channels of the monolith segment having the largest channel diameter.

30. The chemical reactor of claim 26, wherein the drainage device comprises a geometry configuration at an outlet end of the monolith segment having the largest channel diameter.

31. The chemical reactor of claim 30, wherein the geometry configuration comprises bevels.

32. The chemical reactor of claim 25, wherein the monolith segment having the smallest channel diameter is adapted to mate with the monolith catalyst bed.

33. The chemical reactor of claim 25, wherein the diameter and shape of the channels are such that an operating window of the reactor in countercurrent operation is extended.

34. A device for extending a flooding limit of a packed column, comprising:
a plurality of flow channels stacked in order of increasing effective channel hydraulic diameter.

35. The device of claim 34, further comprising means for draining liquid out of the flow channels.

36. A method for draining fluid out of a packed column so as to extend the flooding limit of the packed column, comprising:
passing fluid from an outlet end of the packed column through a flow column having a plurality of channels stacked in order of increasing effective channel hydraulic diameter.

37. The method of claim 36, further comprising draining liquid out of the flow column.
